(19) United States
(12) Patent Application Publication
(10) Pub. No.: US 2026/0004222 A1
(43) Pub. Date: Jan. 1, 2026

(54) METHODS AND SYSTEMS FOR ADAPTIVE DATA TREND PREDICTION AND VISUALIZATION

(71) Applicant: The Prudential Insurance Company Of America, Newark, NJ (US)

(72) Inventors: John Sciacchitano, Berkeley Heights, NJ (US); Dustin Helquist, Alpine, UT (US); Abhii Parakh, Jersey City, NJ (US); Lauren Mattison, Bridgewater, NJ (US); Joe Portella, Lake Hopatcong, NJ (US); Rossana Bandyopadhyay, Mason, OH (US); Jason Kapel, Denver, CO (US); Harsha Vanjani, Kearny, NJ (US); Kahang Ngau, N. Bethesda, MD (US); Amborish Baruah, Frisco, TX (US); Nga Than, Bellevue, WA (US)

(21) Appl. No.: 19/248,013

(22) Filed: Jun. 24, 2025

Related U.S. Application Data
(60) Provisional application No. 63/666,593, filed on Jul. 1, 2024.

(51) Int. Cl. G06Q 10/0639; G06N 20/00

(52) U.S. Cl. CPC G06Q 10/06393; G06N 20/00

(57) ABSTRACT

This application is directed to adaptively predicting and visualizing a trend of a large set of complex data (e.g., process data, performance data). A computer system executes an application for tracking a plurality of metrics that are associated with a project and include a set of process metrics and a set of performance metrics. Historical data of the plurality of metrics include a temporal series of historical metric indicators of each metric, and are applied to train a performance projection model. Current data include a temporal series of current metric indicators of each of the plurality of metrics. At a first time, while collecting the current data, the computer system applies the performance projection model to process a subset of current metric indicators and generate a predicted performance trend for a target projection length. The predicted performance trend is visualized jointly with the subset of current metric indicators.

### RELATED APPLICATION

This application claims priority to U.S. Provisional Patent Application No. 63/666,593, entitled “Methods and Systems for Adaptive Data Trend Prediction and Visualization,” filed Jul. 1, 2024, which is hereby incorporated by reference in its entirety.

### TECHNICAL FIELD

This application relates generally to data technology including, but not limited to, methods, systems, non-transitory computer-readable media, and user interfaces for managing, generating prediction for, and visualizing a large set of complex data interactively.

### BACKGROUND

Processing complex data can often present a formidable challenge due to its multifaceted nature. One significant difficulty arises from the sheer volume of information involved, which can overwhelm traditional analytical methods and tools. Additionally, the intricate interrelationships within the data, spanning various dimensions and variables, can confound attempts at straightforward analysis. Another hurdle lies in the inherent ambiguity or noise present in many datasets, which can obscure meaningful patterns and trends. Furthermore, integrating diverse data sources with disparate formats and structures adds another layer of complexity, requiring sophisticated techniques for normalization and standardization. Overall, navigating the intricacies of complex data demands not only advanced computational capabilities but also a nuanced understanding of the domain to extract actionable insights effectively.

### SUMMARY

Various embodiments of this application are directed to methods, systems, devices, non-transitory computer-readable media for adaptively predicting and visualizing a trend of a large set of complex data (e.g., process data, performance data). An information management platform consolidates a plurality of data associated with different projects from multiple data resources and provides supplement information (e.g., performance trend, alert events) for individual projects based on the consolidated data, thereby allowing the projects to be dynamically managed with desirable performance (e.g., meet an expected performance trend, have less issues, have issues addressed or mitigated promptly). The projects are normally managed via an information management application hosted on a server. While process data of the projects are collected by a host server itself, the host server also collects associated performance data (e.g., provided by third party servers distinct from the host server). The information management application consolidates its own process data with the associated performance data for further processing on the host server. The host server does not need to communicate project information and its custom data processing rules to the third-party servers for the purposes of driving the third-party servers to process the associated performance data according to its custom data processing rules. By these means, the host server can fully utilize a large volume of complex data provided by a variety of third-party servers to generate high-quality supplemental information in real time without breaching confidentiality of individual projects.

In one aspect, a method is implemented at a computer system for real-time data prediction and visualization. The method includes executing an information management application for tracking a plurality of metrics associated with a project, and the plurality of metrics include a set of process metrics and a set of performance metrics. The method further includes extracting, from a historical database, historical data of the plurality of metrics including a temporal series of historical metric indicators of each metric, and each historical metric indicator corresponds to a respective sampling window having a respective temporal length. The method further includes generating current data including a temporal series of current metric indicators of each of the plurality of metrics, and each current metric indicator corresponds to a respective sampling window having a respective temporal length. The method further includes identifying a target projection length and training a performance projection model using the historical data. The method further includes, at a first time, while collecting the current data, identifying a subset of current metric indicators that corresponds to a current prediction window and includes a recent current indicator sampled immediately before or at the first time. The method further includes applying the performance projection model to process the subset of current metric indicators, thereby generating a predicted performance trend corresponding to a current trend window identified by the target projection length, and visualizing the predicted performance trend of the one or more first performance metrics jointly with the subset of current metric indicators.

In some embodiments, training the performance projection model further includes grouping the temporal series of historical metric indicators of a subset of metrics to a plurality of metric indicator sets, and each metric indicator set corresponds to a respective trend window having the target projection length. Training the performance projection model further includes, for each of the plurality of metric indicator sets: determining a respective performance trend corresponding to the respective trend window for one or more first performance metrics; using the respective performance trend as a ground truth; identifying a subset of historical metric indicators, which is sampled in a respective prediction window that precedes at least a subset of the respective trend window; and training the performance projection model using the subset of historical metric indicators and the respective performance trend.

In another aspect, some implementations include a computer system that includes one or more processors and memory having instructions stored thereon, which when executed by the one or more processors cause the processors to perform any of the above methods.

In yet another aspect, some implementations include a non-transitory computer-readable medium, having instructions stored thereon, which when executed by one or more processors cause the processors to perform any of the above methods.

These illustrative embodiments and implementations are mentioned not to limit or define the disclosure, but to provide examples to aid understanding thereof. Additional embodiments are discussed in the Detailed Description, and further description is provided there.

### BRIEF DESCRIPTION OF THE DRAWINGS

For a better understanding of the various described implementations, reference should be made to the Detailed Description below, in conjunction with the following drawings in which like reference numerals refer to corresponding parts throughout the figures.

FIG. 1 is an example data processing environment having one or more servers communicatively coupled to one or more client devices, in accordance with some embodiments.

FIG. 2 is an example data processing environment in which an application server delegates one or more alternative servers to collect and process performance data, in accordance with some embodiments.

FIG. 3A is a block diagram illustrating a server system configured to process data for projection and visualization, in accordance with some embodiments.

FIG. 3B is a block diagram illustrating a client device configured to execute an information management application, in accordance with some embodiments.

FIG. 4 is an example data processing environment for training and applying a neural network-based machine learning model for processing visual and/or audio data, in accordance with some embodiments.

FIG. 5A is an example neural network applied to process data in an NN-based machine learning model, in accordance with some embodiments, and FIG. 5B is an example node in the neural network, in accordance with some embodiments.

FIG. 6 is a flow diagram of an example process for predicting a predicted performance trend using a performance projection model, in accordance with some embodiments.

FIG. 7 is a diagram illustrating an example correlation map among project phases, process metrices, and performance metrics of a project, in accordance with some embodiments.

FIG. 8A is a diagram illustrating an example user interface including a qualitative predicted performance trend, in accordance with some embodiments.

FIG. 8B is a diagram illustrating an example user interface on which an average, a standard deviation, and threshold are marked for a curve of a first performance metric, in accordance with some embodiments.

FIGS. 9A and 9B are two diagram illustrating two example user interfaces showing quantitative predicted performance trends, in accordance with some embodiments.

FIGS. 10A and 10B illustrate a flow diagram of an example method for real-time data prediction and visualization, in accordance with some embodiments.

Like reference numerals refer to corresponding parts throughout the several views of the drawings.

### DETAILED DESCRIPTION

Reference will now be made in detail to specific embodiments, examples of which are illustrated in the accompanying drawings. In the following detailed description, numerous non-limiting specific details are set forth in order to assist in understanding the subject matter presented herein. But it will be apparent to one of ordinary skill in the art that various alternatives may be used without departing from the scope of claims and the subject matter may be practiced without these specific details. For example, it will be apparent to one of ordinary skill in the art that the subject matter presented herein can be implemented on many types of electronic devices with digital video capabilities.

Various embodiments of this application are directed to an information management platform that consolidates a plurality of data associated with different projects from multiple data resources and provides supplement information (e.g., performance trend, alert events) for individual projects based on the consolidated data, thereby allowing the projects to be dynamically managed with desirable performance (e.g., meet an expected performance trend, have less issues, have issues addressed or mitigated promptly). The projects are normally managed via an information management application hosted on a server. While process data of the projects are collected by a host server itself, the host server also collects associated performance data provided by third party servers distinct from the host server. The information management application consolidates its own process data with the associated performance data for further processing on the host server. The host server does not need to communicate project information and its custom data processing rules to the third-party servers for the purposes of driving the third-party servers to process the associated performance data according to its custom data processing rules. By these means, the host server can fully utilize a large volume of complex data provided by a variety of third-party servers to generate high-quality supplemental information in real time without breaching confidentiality of individual projects.

In some embodiments, a host server collects data of a plurality of metrices associated with a project. The plurality of metrics includes a set of process metrics and a set of performance metrics. Process data (e.g., metric indicators) are collected for the set of process metrics in real time by the host server or another server controlled by the host server. In some embodiments, the set of performance metrics includes performance data collected for the set of performance metrics successively after each of an operation, a step, a phase, an entire project or the like has been completed. The performance data may be collected and/or analyzed by a third-party server. In some embodiments, natural language data are collected from individual users in a subjective and descriptive format, and include user feedback messages 220 regarding the project. The natural language data may be further processed to extract performance features. The performance data include the natural language data, the performance features, or both.

In some embodiments, an alert message is issued indicating that a metric is out of a predefined range, when the host server detects an issue based on the process and performance data. The alert message may provide a subset of process data, performance data, and supplemental data (e.g., associated with the user feedback). A user may choose to explore the issue based on the alert message. Further, in some embodiments, the metric may stay out of the predefined range (e.g., have a “at risk” state) for an extended duration of time (e.g., two weeks). The user may choose to take an action to control the metric into the predefined range. Additionally, in some embodiments, a performance trend is predicted using machine learning based on current data collected for the process and performance data. In some embodiments, one of more of the process data, the performance data, the alert message, and the performance trend are consolidated and visualized on a graphical user interface. For example, the user interface includes a dashboard.

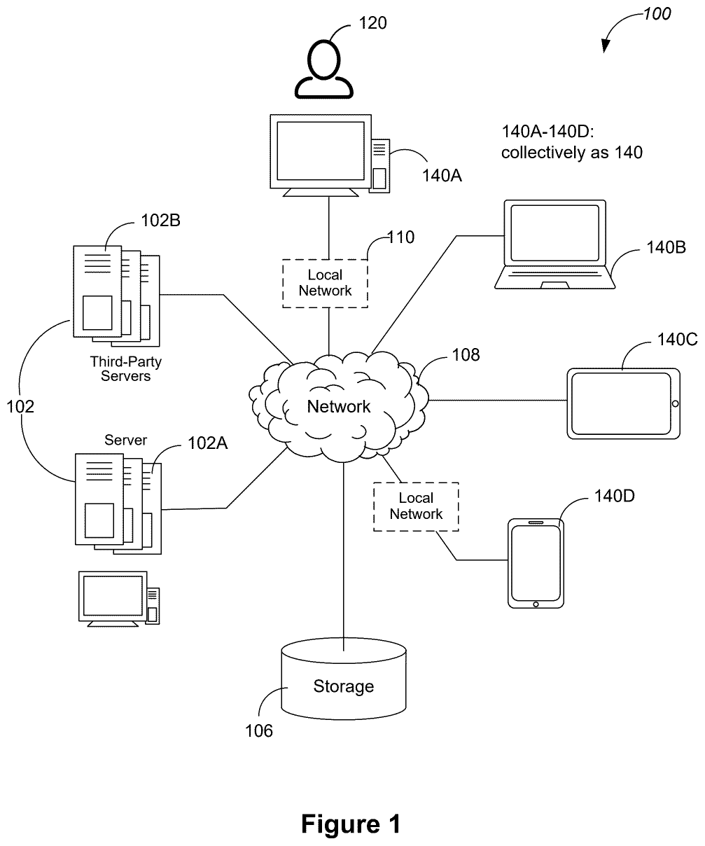

FIG. 1 is an example data processing environment having one or more servers 102 communicatively coupled to one or more client devices 140 (also called edge devices or electronic devices), in accordance with some embodiments. The one or more client devices 140 may be, for example, desktop computers 140A, laptop computers 140B, tablet computers 140C, mobile phones 140D, or any other computing devices. Each client device 140 can collect data or user inputs, executes user applications, and present outputs on its user interface. The collected data or user inputs can be processed locally at the client device 140 and/or remotely by the server(s) 102. The one or more servers 102 provide system data (e.g., boot files, operating system images, and user applications) to the client devices 140, and in some embodiments, processes the data and user inputs received from the client device(s) 140 when the user applications are executed on the client devices 140. In some embodiments, the data processing environment 100 further includes a storage 106 for storing data related to the servers 102, client devices 140, and applications executed on the client devices 140. In some embodiments, the storage 106 includes one or more databases for storing the data in an organized manner.

The one or more servers 102 are configured to enable real-time data communication with the client devices 140 that are remote from each other or from the one or more servers 102. Further, in some embodiments, the one or more servers 102 are configured to implement data processing tasks that cannot be or are preferably not completed locally by the client devices 140. For example, the client devices 140 include a laptop computer 140B that executes an information management application for tracking and visualizing a plurality of metrics associated with a project. The one or more servers 102 collects historical data and current data concerning the project or other related projects from one or more data sources. The historical data and current data are consolidated, processed, and visualized interactively in real time. For example, such data are matched with other data, categorized, or applied to synthesize related data (e.g., predict a predicted performance trend, generate an alert message). In some embodiments, historical data and current data are provided by multiple data sources, have unclear or weak correlations, and include natural language data collected from individual users in a subjective and descriptive format. Stated another way, a server system may include a plurality of servers 102 (e.g., a host server 102A and alternative servers 102B) configured to create an information management platform to collect, process, and visualize a large volume of complex data, which cannot be accomplished by human.

The one or more servers 102, one or more client devices 140, and storage 106 are communicatively coupled to each other via one or more communication networks 108, which are the medium used to provide communications links between these devices and computers connected together within the data processing environment 100. The one or more communication networks 108 may include connections, such as wire, wireless communication links, or fiber optic cables. Examples of the one or more communication networks 108 include local area networks (LAN), wide area networks (WAN) such as the Internet, or a combination thereof. The one or more communication networks 108 are, optionally, implemented using any known network protocol, including various wired or wireless protocols, such as Ethernet, Universal Serial Bus (USB), FIREWIRE, Long Term Evolution (LTE), Global System for Mobile Communications (GSM), Enhanced Data GSM Environment (EDGE), code division multiple access (CDMA), time division multiple access (TDMA), Bluetooth, Wi-Fi, voice over Internet Protocol (VOIP), Wi-MAX, or any other suitable communication protocol. A connection to the one or more communication networks 108 may be established either directly (e.g., using 3G/4G connectivity to a wireless carrier), or through a network interface 110 (e.g., a router, switch, gateway, hub, or an intelligent, dedicated whole-home control node), or through any combination thereof. As such, the one or more communication networks 108 can represent the Internet of a worldwide collection of networks and gateways that use the Transmission Control Protocol/Internet Protocol (TCP/IP) suite of protocols to communicate with one another. At the heart of the Internet is a backbone of high-speed data communication lines between major nodes or host computers, consisting of thousands of commercial, governmental, educational and other computer systems that route data and messages.

In some embodiments, deep learning techniques are applied by an information management application that collects, processes, and visualizes data associated with a project. In some embodiments, in these deep learning techniques, machine learning models (e.g., performance projection model) are created based on one or more neural networks to process the data. A machine learning model is trained with training data (e.g., historical data) before they are applied to process current data that are collected in real time for data inference. Further, in some embodiments, the machine learning model is further trained using the current data.

In some embodiments, both model training and data inference are implemented locally at each individual client device 140. The client device 140 obtains the training data from the one or more servers 102 or storage 106, applies the training data to train the machine learning models, and uses the learning models to process current data. Alternatively, in some embodiments, data inference is implemented locally at a client device 140, while model training is implemented remotely at a server 102 associated with the client device 140. The server 102B obtains the training data from itself, another server 102 or the storage 106 and applies the training data to train the machine learning models. The trained machine learning models are optionally stored in the server 102B or storage 106. The client device 140 imports the trained machine learning models from the server 102B or storage 106, processes the current data using the machine learning models, and generates data processing results (e.g., a performance projection trend, an alert message) to be presented on a user interface.

Alternatively, in some embodiments, both model training and data inference are implemented remotely at a server 102 (e.g., the server 102A) associated with a client device 140, particularly if a large volume of complex data are involved. The server 102A obtains the training data from itself, another server 102 or the storage 106 and applies the training data to train the machine learning models. The client device 140 receives data processing results from the server 102A and presents the results on a user interface. The client device 140 itself implements no or little data processing on the data processing results. In some embodiments, the client device 140 enters an input to define one or more parameters (e.g., a target projection length) for data inference, and the server 102 generates the data processing results based on the input. Additionally, in some embodiments, a client-side information management application collaborates with a server-side information management application to deliver the data processing results. The client-side information management application presents a user interface where the input from a user is received and data processing results are presented. The server-side information management application collects and processes data (e.g., using the deep learning techniques), and enables display of the user interface.

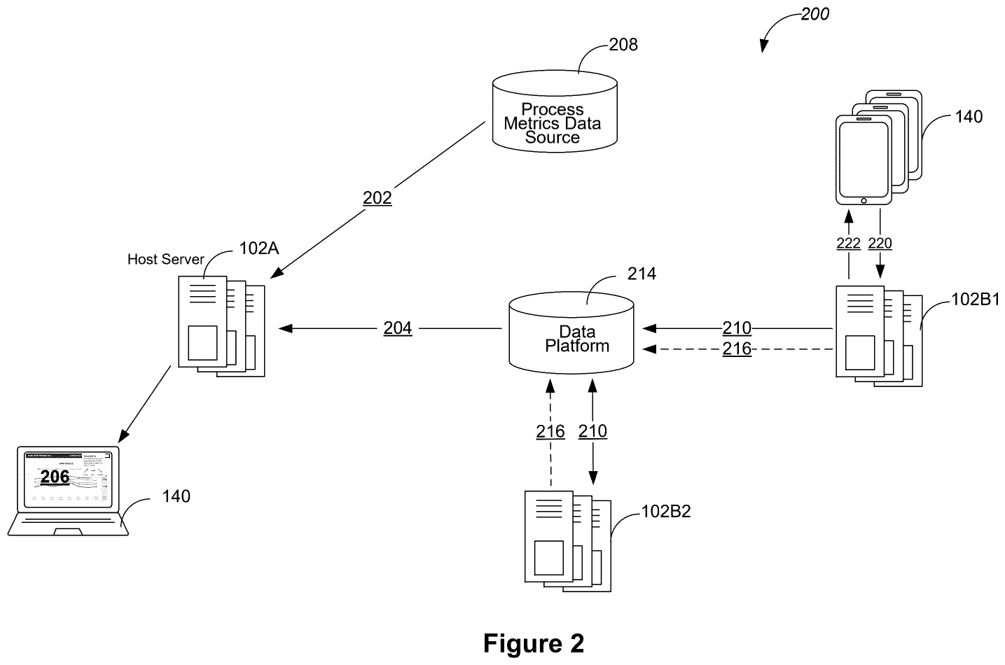

FIG. 2 is an example data processing environment 200 in which a host server 102A delegates one or more alternative servers 102B to collect and process performance data, in accordance with some embodiments. In some embodiments, a server system may include a plurality of servers 102 (e.g., a host server 102A and alternative servers 102B) configured to create an information management platform. The host sever 102A is configured to collect, process, and visualize at least process data 202 in real time, and each alternative server 102B collects, processes, and/or provides to the host server 102, a set of respective performance data 204 (e.g., survey responses 210, performance features 216). A client device 140 is configured to execute an information management application 206 and interact with the host server 102. Particularly, in some embodiments, the one or more alternative servers 102B are involved and interact with the client device 140 indirectly by way of the host server 102.

In some embodiments, the host server 102A extracts process data 202 (e.g., metric indicators of process metrics) from a process metrics data source 208 (e.g., another server 102, a storage 106, or a local storage of the host server 102A), which may be coupled to the information management application 206 using native connections.

In some embodiments, natural language data are collected from individual users in a subjective and descriptive format, and include user feedback messages 220 regarding a project. For example, an alternative server 102B1 is owned by a third party, and manages surveys in response to which the user feedback messages 220 are generated. The alternative server 102B1 provides survey responses 210 including the user feedback messages 220 (e.g., via a secure file transfer protocol (secure FTP) link) directly to the host server 102A or indirectly to another alternative server 102B2 designated by the host server 102. In some embodiments, the survey responses 210 are provided to the alternative server 102B2 by way of a data platform 214. In some embodiments, in the alternative server 102B2, the survey responses 210 are queried and transformed into performance data 204 having a predefined format that is used by the information management application 206, e.g., by aggregating the survey responses 210 into a plurality of time periods, determining thresholds, or assigning statuses.

Additionally, in some embodiments, the user feedback messages 220 may be further processed to extract performance features 216 (e.g., using a machine learning model) at one of the host server 102A and the alternative servers 102B1 and 102B2. When generated at the alternative servers 102B1 and 102B2, the performance features 216 are provided to the host server 102 (e.g., by way of the data platform 214 and/or using the secure FTP link. The host server 102A further processes the process data 202 and performance data 204 and visualizes data processing results on a client device 140.

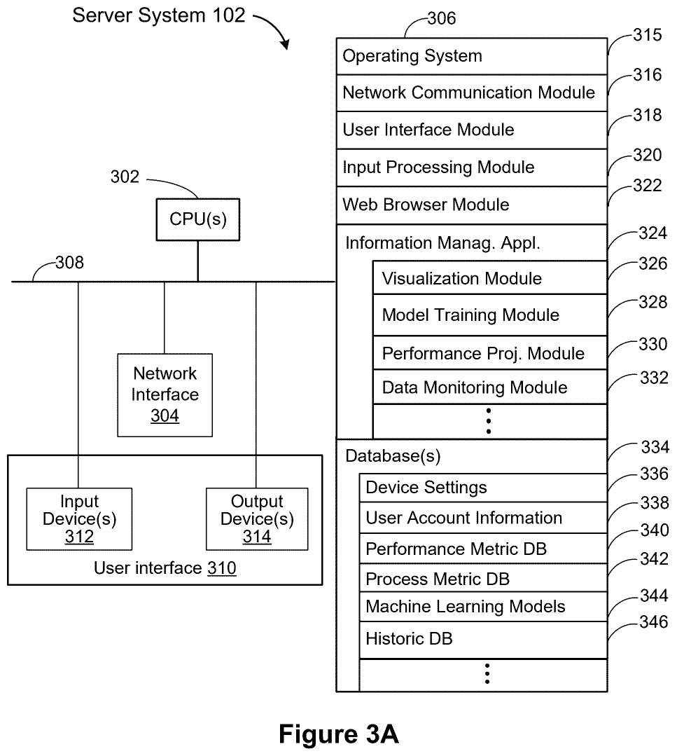

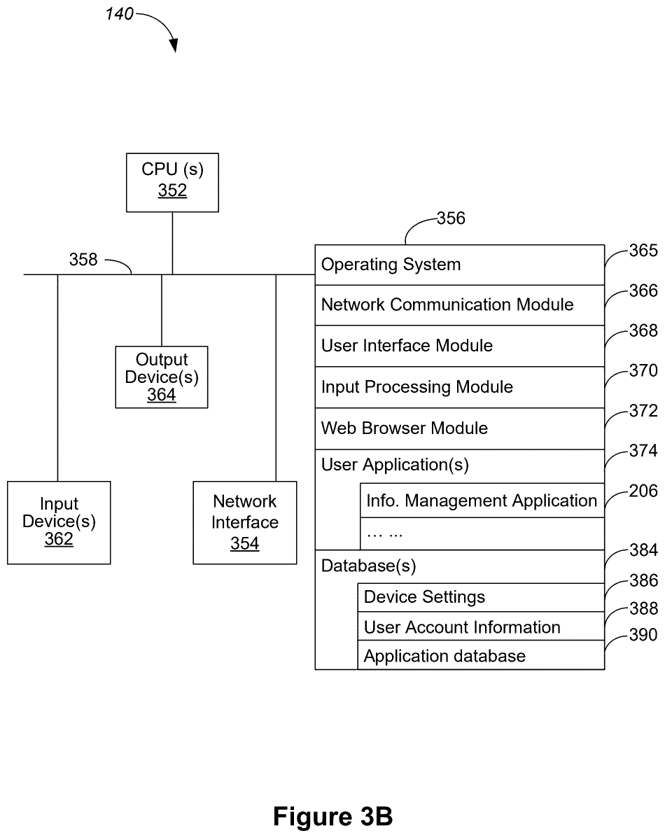

FIG. 3A is a block diagram illustrating a server system 102 configured to process data associated with a project, in accordance with some embodiments. The server system 102 includes a host server 102A, one or more alternative servers 102B, a storage 106, or a combination thereof. The server system 102 typically includes one or more processing units (CPUs) 302, one or more network interfaces 304, memory 306, and one or more communication buses 308 for interconnecting these components (sometimes called a chipset). In some embodiments, the server system 102 includes a user interface system 310 that further includes one or more input devices 312 that facilitate user input or one or more output devices 314 that enable presentation of user interfaces and display content.

Memory 306 includes high-speed random access memory, such as DRAM, SRAM, DDR RAM, or other random access solid state memory devices; and, optionally, includes non-volatile memory, such as one or more magnetic disk storage devices, one or more optical disk storage devices, one or more flash memory devices, or one or more other non-volatile solid state storage devices. Memory 306, optionally, includes one or more storage devices remotely located from one or more processing units 302. Memory 306, or alternatively the non-volatile memory within memory 306, includes a non-transitory computer readable storage medium. In some embodiments, memory 306, or the non-transitory computer readable storage medium of memory 306, stores the following programs, modules, and data structures, or a subset or superset thereof:
Operating system 315 including procedures for handling various basic system services and for performing hardware dependent tasks;
Network communication module 316 for connecting each server 102 to other devices (e.g., server 102, client device 140, or storage 106) via one or more network interfaces 304 (wired or wireless) and one or more communication networks 108, such as the Internet, other wide area networks, local area networks, metropolitan area networks, and so on;
User interface module 318 for enabling presentation of information (e.g., a graphical user interface for an application 206, widgets, websites and web pages thereof, and/or games, audio and/or video content, text, etc.) at each client device 140 via one or more output devices 312 (e.g., displays, speakers, etc.); · Input processing module 320 for detecting one or more user inputs or interactions from one of the one or more input devices 312 and interpreting the detected input or interaction;
Web browser module 322 for navigating, requesting (e.g., via HTTP), and displaying websites and web pages thereof;
Server-side information management application 206 for execution by the server system 102 to collect, process, and visualize data associated with a plurality of metrics of one or more projects, where the server-side information management application 206 further includes one or more of a visualization module 324 for visualizing the data, a model training module 326 for receiving training machine learning models that processes data associated with a plurality of metrics of one or more projects, a performance projection module 330, and a data monitoring module 332 for generating an alert message in response to detecting that a metric is out of a predefined range;
One or more databases 334 for storing at least data including one or more of:
   Device settings 336 including common device settings (e.g., service tier, device model, storage capacity, processing capabilities, communication capabilities, etc.) of a server 102;
   User account information 338 for the information management application 206, e.g., user names, security questions, account history data, user preferences, and predefined account settings;
   Performance metric database 340 for storing performance data 204, where in some embodiments, data processing results generated by the information management application 206 are stored in the database 340 as well;
   Process metric database 342 for storing process data 202;
   Machine learning model(s) 344 for processing process data 202, performance data 204, or a combination thereof; and
   Historical database 346 for storing historical data of a plurality of metrics.

Optionally, each of the one or more databases 334 is stored in one of the host server 102A, alternative servers 102B, and storage 106 of the server system 102. Optionally, the one or more databases 240 are distributed in more than one of the server 102A, alternative servers 102B, and storage 106 of the server system 102. In some embodiments, more than one copy of the above data is stored at distinct devices, e.g., two copies of the machine learning models 344 are stored at the host server 102A and storage 106, respectively.

Each of the above identified elements may be stored in one or more of the previously mentioned memory devices, and corresponds to a set of instructions for performing a function described above. The above identified modules or programs (i.e., sets of instructions) need not be implemented as separate software programs, procedures, modules or data structures, and thus various subsets of these modules may be combined or otherwise re-arranged in various embodiments. In some embodiments, memory 306, optionally, stores a subset of the modules and data structures identified above. Furthermore, memory 306, optionally, stores additional modules and data structures not described above.

FIG. 3B is a block diagram illustrating a client device 140 configured to present data associated with a project, in accordance with some embodiments. The client device 140 typically includes one or more processing units (CPUs) 352, one or more network interfaces 354, memory 356, and one or more communication buses 358 for interconnecting these components (sometimes called a chipset). The client device 140 includes one or more input devices 362 that facilitate user input or one or more output devices 364 that enable presentation of user interfaces and display content.

Memory 356 includes high-speed random access memory, such as DRAM, SRAM, DDR RAM, or other random access solid state memory devices; and, optionally, includes non-volatile memory, such as one or more magnetic disk storage devices, one or more optical disk storage devices, one or more flash memory devices, or one or more other non-volatile solid state storage devices. Memory 356, optionally, includes one or more storage devices remotely located from one or more processing units 352. Memory 356, or alternatively the non-volatile memory within memory 356, includes a non-transitory computer readable storage medium. In some embodiments, memory 356, or the non-transitory computer readable storage medium of memory 356, stores the following programs, modules, and data structures, or a subset or superset thereof:
Operating system 365 including procedures for handling various basic system services and for performing hardware dependent tasks;
Network communication module 366 for connecting each device 140 to other devices (e.g., server 102, client device 140, or storage 106) via one or more network interfaces 354 (wired or wireless) and one or more communication networks 108;
User interface module 368 for enabling presentation of information at each client device 140 via one or more output devices 362 (e.g., displays, speakers, etc.);
Input processing module 370 for detecting one or more user inputs or interactions from one of the one or more input devices 362 and interpreting the detected input or interaction;
Web browser module 372 for navigating, requesting (e.g., via HTTP), and displaying websites and web pages thereof;
One or more user applications 374 for execution by the client device 140 (e.g., games, social network applications, smart home applications, and/or other web or non-web based applications), where in some embodiments, the user application(s) 374 include a client-side information management application 206 for execution by the client device 140 to visualize data associated with a plurality of metrics of one or more projects;
One or more databases 384 for storing at least data including one or more of:
   Device settings 386 including common device settings (e.g., service tier, device model, storage capacity, processing capabilities, communication capabilities, etc.) of a server 102;
   User account information 388 for the information management application 206, e.g., user names, security questions, account history data, user preferences, and predefined account settings; and
   Application database 390 for storing a subset of process data 202, performance data 204, data processing results, and machine learning model(s) 344 locally in support of execution of the information management application 206.

Each of the above identified elements may be stored in one or more of the previously mentioned memory devices, and corresponds to a set of instructions for performing a function described above. The above identified modules or programs (i.e., sets of instructions) need not be implemented as separate software programs, procedures, modules or data structures, and thus various subsets of these modules may be combined or otherwise re-arranged in various embodiments. In some embodiments, memory 356, optionally, stores a subset of the modules and data structures identified above. Furthermore, memory 356, optionally, stores additional modules and data structures not described above.

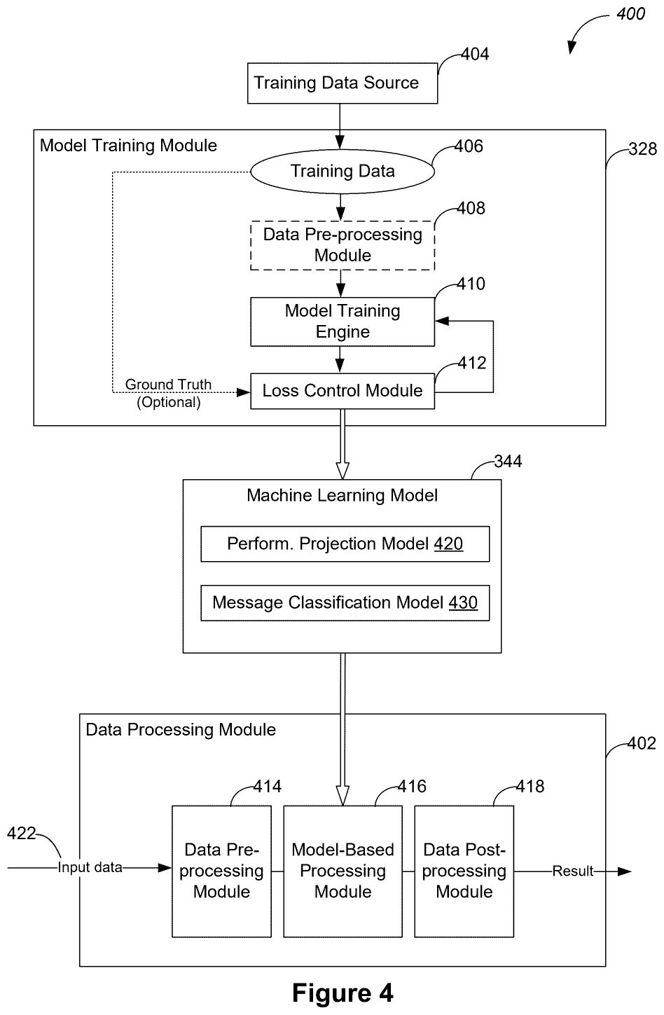

FIG. 4 is another example of a data processing system 400 for training and applying a neural network based (NN-based) machine learning model 344 for processing content data (e.g., video, image, audio, or textual data), in accordance with some embodiments. The data processing system 400 includes a model training module 328 for establishing the machine learning model 344 and a data processing module 402 for processing the content data using the machine learning model 344. In some embodiments, both of the model training module 328 and the data processing module 402 are located on a client device 140 of the data processing system 400, while a training data source 404 (e.g., process metrics data source 208 in FIG. 2) distinct from the client device 140 provides training data 406 to the client device 140. The training data source 404 is optionally a server 102 or storage 106. Alternatively, in some embodiments, the model training module 328 and the data processing module 402 are both located on a server 102 (e.g., the host server 102A) of the data processing system 400. The training data source 404 providing the training data 406 is optionally the server 102 itself, another server 102, or the storage 106. Additionally, in some embodiments, the model training module 328 and the data processing module 402 are separately located on a server 102 (e.g., the host server 102A) and client device 140, and the server 102 provides the trained machine learning model 344 to the client device 140.

The model training module 328 includes one or more data pre-processing modules 408, a model training engine 410, and a loss control module 412. The model training engine 410 receives pre-processed training data 406 provided by the data pre-processing modules 408, further processes the pre-processed training data 406 using an existing machine learning model 344, and generates an output from each training data item. During this course, the loss control module 412 can monitor a loss function comparing the output associated with the respective training data item and a ground truth of the respective training data item. The model training engine 410 modifies the machine learning model 344 to reduce the loss function, until the loss function satisfies a loss criterion (e.g., a comparison result of the loss function is minimized or reduced below a loss threshold). The modified machine learning model 344 is provided to the data processing module 402 to process the content data.

In some embodiments, the model training module 328 offers supervised learning in which the training data 406 is entirely labelled and includes a desired output for each training data item (also called the ground truth in some situations). Conversely, in some embodiments, the model training module 328 offers unsupervised learning in which the training data 406 are not labelled. The model training module 328 is configured to identify previously undetected patterns in the training data 406 without pre-existing labels and with no or little human supervision. Additionally, in some embodiments, the model training module 328 offers partially supervised learning in which the training data 406 are partially labelled.

The data processing module 402 includes a data pre-processing module 414, a model-based processing module 416, and a data post-processing module 418. The data pre-processing modules 414 pre-processes the input data 422. The model-based processing module 416 applies the trained machine learning model 344 provided by the model training module 328 to process the pre-processed input data. The model-based processing module 416 can also monitor an error indicator to determine whether the input data 422 has been properly processed in the data processing module 402. In some embodiments, the processed input data is further processed by the data post-processing module 418 to present the processed input data in a preferred format or to provide other related information that can be derived from the processed input data.

In some embodiments, the machine learning model 344 includes a performance projection model 420 for predicting a performance trend having a target projection length from a time (e.g., a current time) based on available process data 202 and/or performance data 204 (FIG. 2). In some embodiments, the machine learning model 344 includes a message classification model 430 for extracting performance features 216 (FIG. 2) from user feedback messages 220. The performance features 216 may be applied by the host server 102A as part of the performance data 204.

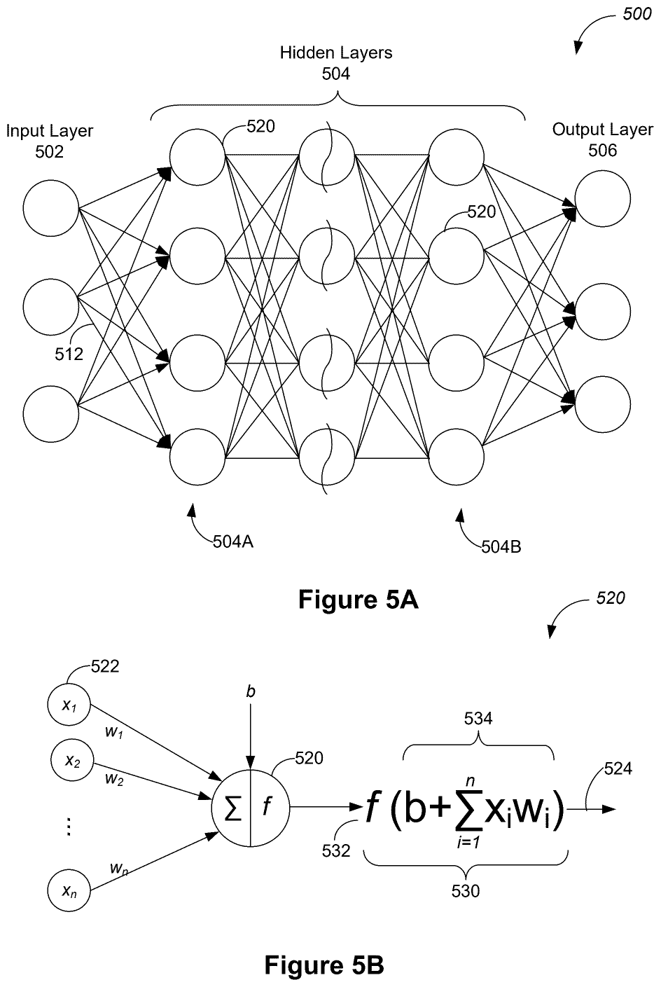

FIG. 5A is a structural diagram of an example neural network 500 applied to process vehicle data in a machine learning model 344, in accordance with some embodiments, and FIG. 5B is an example node 520 in the neural network 500, in accordance with some embodiments. It should be noted that this description is used as an example only, and other types or configurations may be used to implement the embodiments described herein. The machine learning model 344 is established based on the neural network 500. A corresponding model-based processing module 416 applies the machine learning model 344 including the neural network 500 to process vehicle data 112 that has been converted to a predefined data format. The neural network 500 includes a collection of nodes 520 that are connected by links 512. Each node 520 receives one or more node inputs 522 and applies a propagation function 530 to generate a node output 524 from the one or more node inputs. As the node output 524 is provided via one or more links 512 to one or more other nodes 520, a weight w associated with each link 512 is applied to the node output 524. Likewise, the one or more node inputs 522 are combined based on corresponding weights w₁, w₂, w₃, and w₄ according to the propagation function 530. In an example, the propagation function 530 is computed by applying a non-linear activation function 532 to a linear weighted combination 534 of the one or more node inputs 522.

The collection of nodes 520 is organized into layers in the neural network 500. In general, the layers include an input layer 502 for receiving inputs, an output layer 506 for providing outputs, and one or more hidden layers 504 (e.g., layers 504A and 504B) between the input layer 502 and the output layer 506. A deep neural network has more than one hidden layer 504 between the input layer 502 and the output layer 506. In the neural network 500, each layer is only connected with its immediately preceding and/or immediately following layer. In some embodiments, a layer is a “fully connected” layer because each node in the layer is connected to every node in its immediately following layer. In some embodiments, a hidden layer 504 includes two or more nodes that are connected to the same node in its immediately following layer for down sampling or pooling the two or more nodes. In particular, max pooling uses a maximum value of the two or more nodes in the layer for generating the node of the immediately following layer.

In some embodiments, a convolutional neural network (CNN) is applied in a machine learning model 344 to process input data (e.g., process data 202, performance data 204). The CNN employs convolution operations and belongs to a class of deep neural networks. The hidden layers 504 of the CNN include convolutional layers. Each node in a convolutional layer receives inputs from a receptive area associated with a previous layer (e.g., nine nodes). Each convolution layer uses a kernel to combine pixels in a respective area to generate outputs. For example, the kernel may be to a 3×3 matrix including weights applied to combine the pixels in the respective area surrounding each pixel.

In some embodiments, a recurrent neural network (RNN) is applied in the machine learning model 344 to process the input data (e.g., process data 202, performance data 204). Nodes in successive layers of the RNN follow a temporal sequence, such that the RNN exhibits a temporal dynamic behavior. In an example, each node 520 of the RNN has a time-varying real-valued activation. It is noted that in some embodiments, two or more types of neural networks (e.g., both a CNN and an RNN) are applied in the same machine learning model 344 to process the input data jointly.

The training process is a process for calibrating all of the weights wᵢ for each layer of the neural network 500 using training data 406 that is provided in the input layer 502. The training process typically includes two steps, forward propagation and backward propagation, which are repeated multiple times until a predefined convergence condition is satisfied. In the forward propagation, the set of weights for different layers are applied to the input data and intermediate results from the previous layers. In the backward propagation, a margin of error of the output (e.g., a loss function) is measured (e.g., by a loss control module 412), and the weights are adjusted accordingly to decrease the error. The activation function 532 can be linear, rectified linear, sigmoidal, hyperbolic tangent, or other types. In some embodiments, a network bias term b is added to the sum of the weighted outputs 534 from the previous layer before the activation function 532 is applied. The network bias b provides a perturbation that helps the neural network 500 avoid over fitting the training data 406. In some embodiments, the result of the training includes a network bias parameter b for each layer.

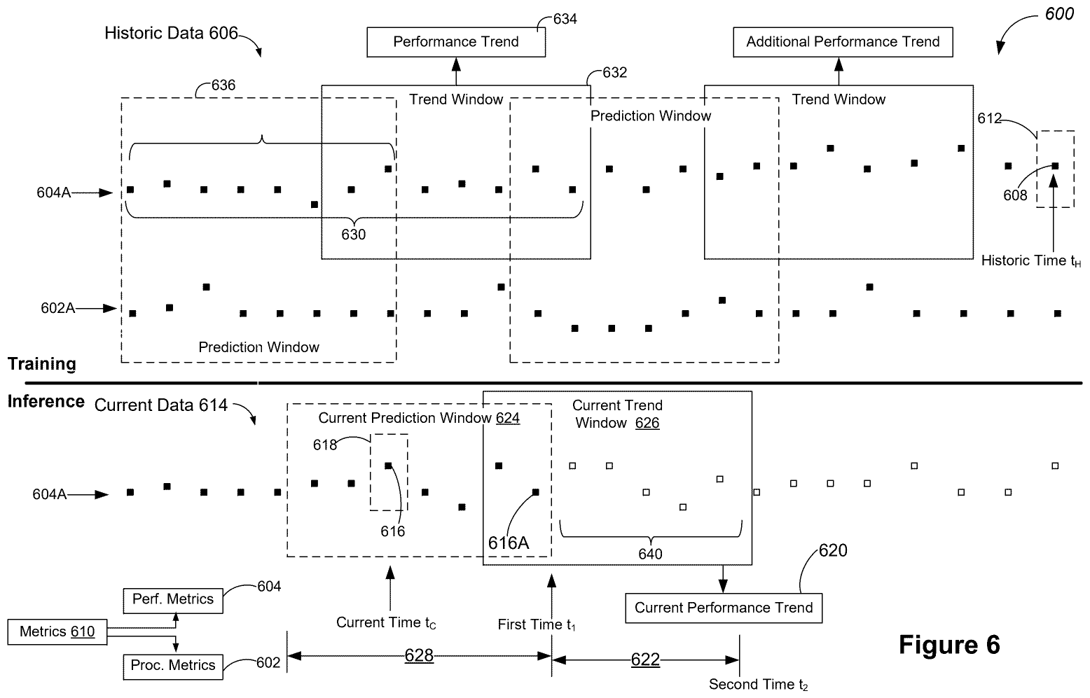

FIG. 6 is a flow diagram of an example process 600 for predicting a predicted performance trend 620 using a performance projection model 420, in accordance with some embodiments. A server system 102 executes an information management application 206 (FIG. 2) for tracking a plurality of metrics 610 associated with a project, and the plurality of metrics 602 including a set of process metrics 602 and a set of performance metrics 604. Historical data 606 of the plurality of metrics 610 are extracted from a historical database 346, and include a temporal series of historical metric indicators of each metric. Each historical metric indicator (e.g., indicator 608) corresponds to a respective sampling window 612 having a respective temporal length. In some embodiments, each historical metric indicator 608 is sampled once in the respective sampling window 612. Alternatively, in some embodiments, a plurality of samples are obtained in the respective sampling window 612, and combined (e.g., averaged) to provide the respective historical metric indicator 608. In some embodiments, respective sampling windows 612 have different temporal lengths for the set of process metrics 602 and the set of performance metrics 604.

The server system 102 may train a performance projection model 420 using the historical data 606 of the plurality of metrics 610. In some embodiments, the performance projection model 420 is based on machine learning, and does not correspond to a deep neural network. Alternatively, in some embodiments, the performance project model 420 includes a deep neural network including a number of hidden layers, and the number is greater than a threshold number (e.g., 8).

The server system 102 generates current data 614 including a temporal series of current metric indicators 616 of each of the plurality of metrics 610, and each current metric indicator 616 corresponds to a respective sampling window 618. The server system 102 identifies a target projection length 622. In some embodiments, the performance projection model 420 is selected from a plurality of models corresponding to different projection lengths (e.g., one week, two weeks, one month, two months, a quarter, a year). In some embodiments, the performance projection model 420 is configured to apply to a plurality of projection lengths including the target projection length 622, which is provided to the performance projection model 420 as an input. In some embodiments, the server system 102 identifies the target projection length 622 by identifying a plurality of predefined projection lengths and receiving a user selection of the target projection length 622 from the plurality of predefined projection lengths.

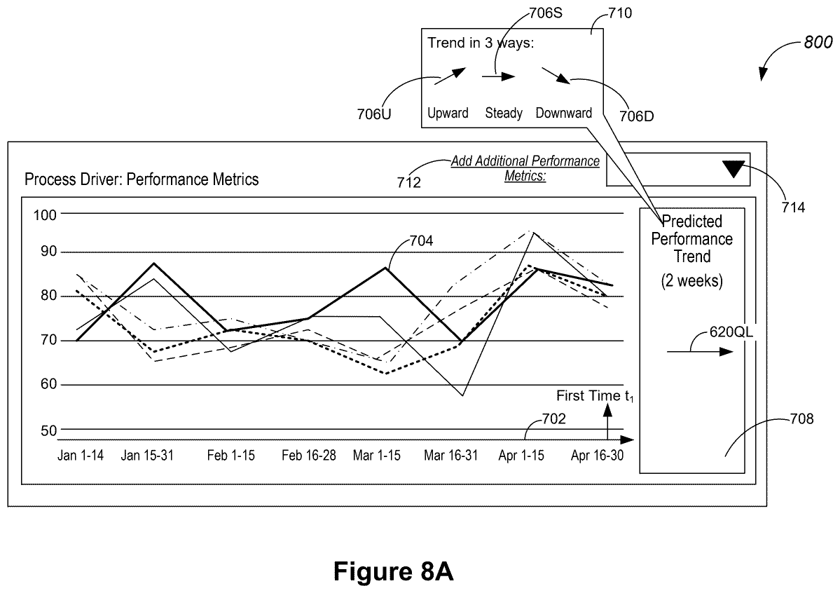

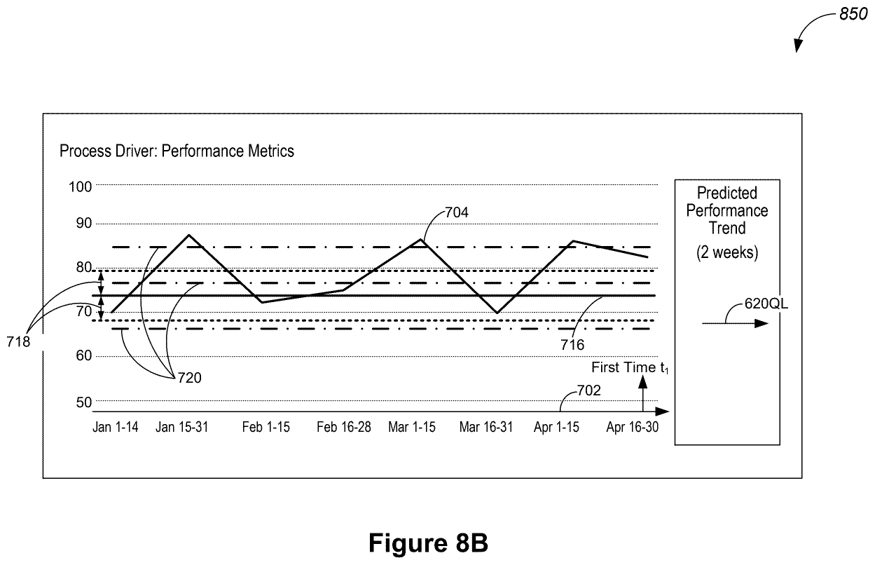

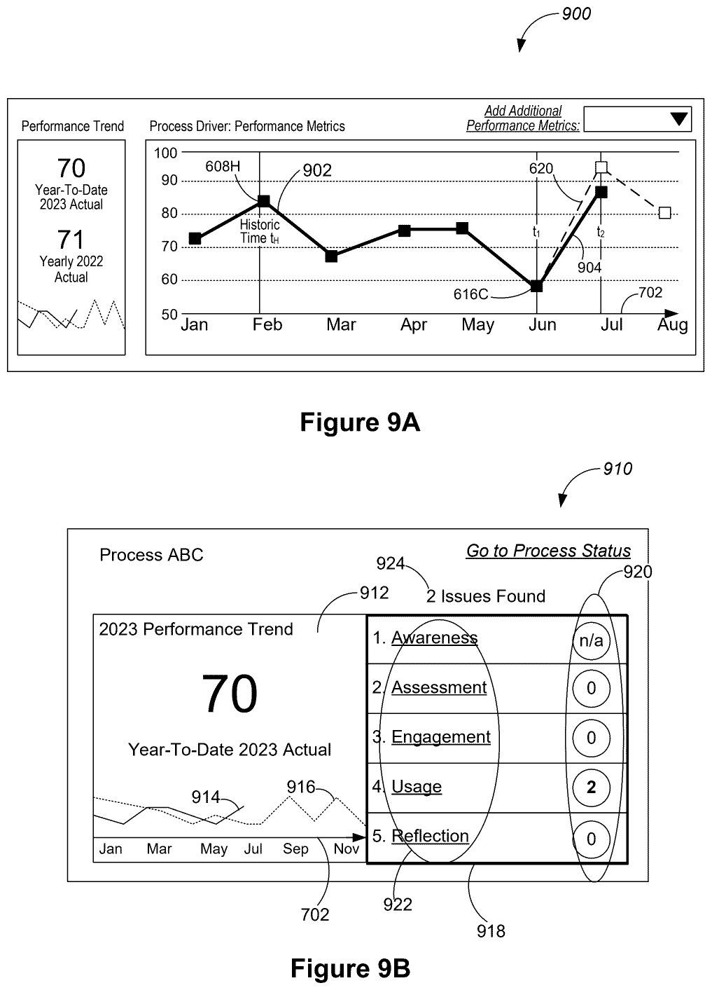

At a first time t₁, while collecting the current data 614, the server system 102 identifying a subset of current metric indicators 616 that corresponds to a current prediction window 624 having a respective temporal length 628 and includes a recent current indicator 616A sampled immediately before or at the first time t₁. The respective temporal length 628 may depend on a type of one or more first performance metrics 604A for which a predicted performance trend 620 is determined. In an example, the temporal length of the current prediction window 624 is a quarter, when a target projection length 622 of the current trend window 626 is two weeks. The performance projection model 420 is applied to process the subset of current metric indicators 616, thereby generating a predicted performance trend 620 of one or more first performance metrics 604A corresponding to a current trend window 626 identified by the target projection length 622. In some embodiments, the predicted performance trend 620 of the one or more first performance metrics 604A are visualized jointly with the subset of current metric indicators 616. More details on visualization of the predicted performance trend 620 are explained with reference to FIGS. 8 and 9A.

The predicted performance trend 620 is generated for the one or more first performance metrics 604A using the performance projection model 420. During training, the historical data 606 of the one or more first performance metrics 604A are used. In some embodiments, the historical data 606 of one or more process metrics 602A or additional performance metrics (not shown) are used to train the performance projection model 420 as well. More specifically, in some embodiments, the temporal series of historical metric indicators of a subset of performance metrics 610 (including the one or more first performance metrics 604A) are grouped to a plurality of metric indicator sets 630. Each metric indicator set 630 corresponding to a respective trend window 632 having the target projection length 622. For each of the plurality of metric indicator sets 630, the server system 102 determines a respective performance trend 634 corresponding to the respective trend window 632 for the one or more first performance metrics 604A, and applies the respective performance trend 634 as a ground truth.

A subset of historical metric indicators is sampled in a respective prediction window 636 that precedes at least a subset of the respective trend window 632. The subset of performance metrics 610 include one or more process metrics 602A, the one or more first performance metrics 604A, or additional performance metrics (not shown). The performance projection model 420 is trained using the subset of historical metric indicators sampled in the prediction window 636 and the respective performance trend 634 determined for the trend window 632.

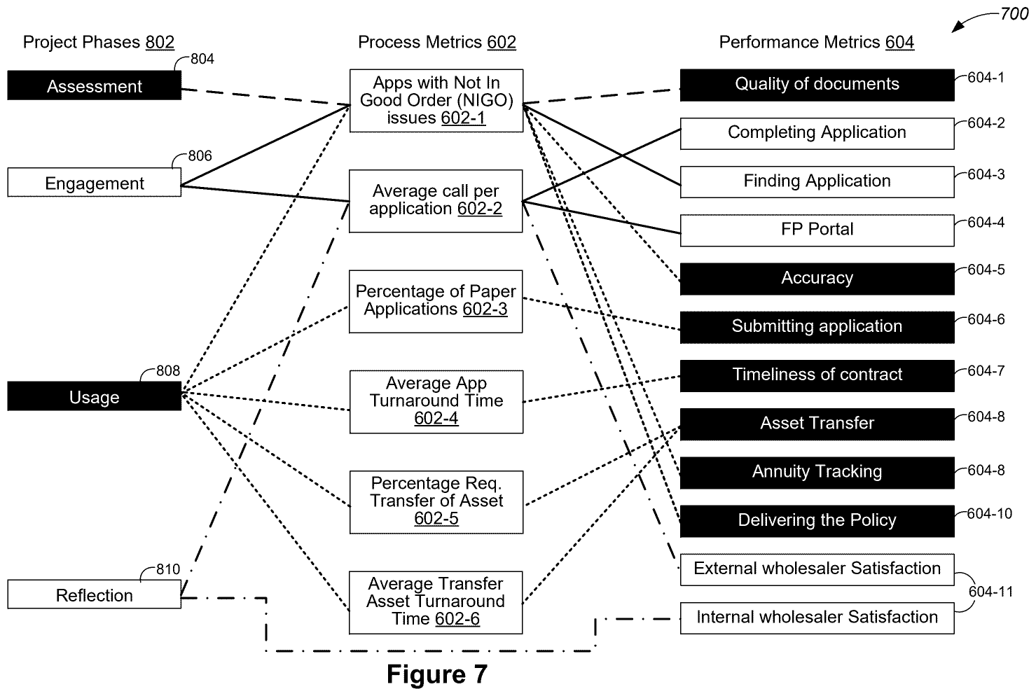

FIGS. 7-9 illustrate different aspects of some exemplary embodiments of the present invention. In this example, there is an information management platform configured to consolidate data from disparate “customer journey” workstreams into a single user interface. These “customer journeys” describe a customer's experience with a company's process for providing a service to the customer. These services include a purchase of an insurance policy or an individual disability claim, among others. Process metrics can be used to provide insight into whether the customer is having a positive or negative experience with the company's service. By tracking certain process metrics, and utilizing the correlations between process metrics to performance, the information management platform can provide visual displays and show predicted trajectory as a performance trend to help administrators determine the effectiveness of the company's processes in real time.

FIG. 7 is a diagram illustrating an example correlation map 700 among project phases 802, process metrices 602 corresponding to process data 202, and performance metrics 604 corresponding to performance data 204 of a project, in accordance with at least the “customer journey” embodiments described in the preceding paragraphs. In this example, the exemplary customer journey corresponds to purchase of an insurance policy from an insurance company. For each project of the customer journey, a customer purchases an insurance policy from the insurance company via assessment, engagement, usage, and reflection. The project phases includes an assessment phase 804 in which the project is previewed, an engagement phase 806 in which one or more users are being engaged for using a certain service, a usage phase 808 in which the one or more users are using the service, and a reflection phase 810 in which user experience and feedback is analyzed. Each of the plurality of metrics 610 is monitored during a process 802 of using the service in real time or after the process 802. Alerts are generated as needed based whether performance metrics indicate that further review is warranted by an administrative user.

By alerting an administrator user to issues that arise within the plurality of projects associated with the customer journey, the administrator has the necessary information to address or mitigate issues that may negatively impact a net promoter score (NPS) and an ease of doing business (EODB). The NPS is a measure used to gauge customer loyalty, satisfaction, and enthusiasm with a company that's calculated by asking customers an example question: “On a scale from 0 to 10, how likely are you to recommend this product/company to a friend or colleague?” In some embodiments, aggregate NPS scores help businesses improve upon service, customer support, delivery, etc. for increased customer loyalty. The EODB refers to how straightforward and efficient it is for a customer to engage in transactions and interactions with a company, relying on factors such as customer service, transaction processing, user experience, and communication, among others.

Each project phase 802 is measured by one or more respective process metrics 602, each of which is associated with one or more respective performance metrics 604 (also called voice of customer (VOC) metrics). In some embodiments, the one or more respective performance metrics 604 are determined based on feedback information collected from the customers and could be subjective, while the one or more respective process metrics 602 are objectively determined based on parameters of the projects. The correlation map 700 helps connect the performance metrics 604 (e.g., customer feedback) from each journey to other correlating process metrics 602 controlled by an organization of the administrator user 120 (e.g., an insurance company), which will eliminate the need for the administrator user 120 to track down multiple data sources and help the administrator user 120 to fully understand the customer issues that can arise within their corresponding project of their journey.

More specifically, in some embodiments, the set of process metrics 602 include one or more of: a number of requests with not in good order (NIGO) issues 602-1, an average call per request 602-2, a percentage of paper requests 602-3, an average request turnaround time 602-4, a percentage of requests requiring asset transfer 602-5, and an average asset transfer turnaround time 602-6. The number of requests with not in good order (NIGO) issues 602-1 may be used in assessment, engagement, and usage, identifying how many requests (e.g., insurance policy applications) have errors. An average call per request 602-2 may correspond to calls received for each insurance request, independently of call reasons and project phases. A percentage of paper requests 602-3 may correspond to insurance applications including those requiring additional documentation and third-party processing to transfer assets, which may delay a turnaround time of insurance applications. An average request turnaround time 602-4 may measure a time between receiving a request and completion of assert transfer. A percentage of requests requiring asset transfer 602-5 may correspond to insurance applications requiring additional documentation and third-party processing to transfer assets. An average asset transfer turnaround time 602-6 measures a time for insurance policy applications that require additional processing to transfer their asset.

In some embodiments, the set of performance metrics 604 include one or more: quality of documents 604-1, completing request 604-2, finding request 604-3, FP portal 604-4, accuracy level 604-5, submitting request 604-6, timeliness 604-7, asset transfer 604-8, annuity tracking 604-9, delivering the policy 604-10, and satisfaction rate 604-11. The quality of documents 604-1 may indicate advisor opinion on the quality of documents provided, such as overall presentation and content that are displayed within insurance contracts and illustrations during an assessment phase. The completing request 604-2 may indicate whether the details asked within an insurance application were an easy task to complete. The finding request 604-3 may indicate whether forms were easily available either online or paper. The user application portal 604-4 may indicate whether overall satisfaction in using an user application portal, The accuracy level 604-5 may indicate whether an insurance request was processed accurately. The submitting request 604-6 may indicate whether it was easy to submit a request. The timeliness 604-7 may indicate whether an insurance contract was issued in a timely matter. The asset transfer 604-8 may indicate whether the transfer of assets was a smooth process. The annuity tracking 604-9 may indicate how easy it is to track a contract status either online or by interacting with an agent. The delivering the policy 604-10 may indicate a satisfaction level on the mode of delivery of the contract, whether by eDelivery or paper, and whether all documents were received. The satisfaction rate 604-11 may indicate an overall satisfaction level on the support a customer receive.

In some embodiments, each project phase 802 is associated with a subset of process metrics 602, each of which is further associated with a subset of respective performance metrics 604. Association of a certain process metric 602 and a certain performance metric 604 depends on the project phases 802. For example, average call per application 602-2 might be associated with the engagement 806 and reflection 801 of the project phases 802. Some implementations of this application are directed to visualization associations of the process metrics 602 and performance metrics 604 based on complex data, thereby allowing the administrator user to identify weak links in the customer journeys and associated phases and enhance and improve customer experience.

Historical data 606 (FIG. 6) of the process metrics 602 and the performance metrics 604 are stored for a plurality of projects associated with different customers engaged in a customer journey, so are current data 614 (FIG. 6) of the process metrics 602 and the performance metrics 604 are tracked in real time. In some embodiments, a machine learning model 344 (e.g., a performance projection model 420 in FIGS. 4 and 6) is applied to generate a predicted performance trend 620, examining current data 614 (e.g., process and performance data) and statistically determine an effect of each metric 610. Historical data 606 are used to train the machine learning model 344 (e.g., a performance projection model 420) before the model 344 is applied to process a subset of current data 614 and determine the predicted performance trend 620 (e.g., a qualitative representation 620QL in FIG. 8A, a quantitative predicted performance trend 620 in FIG. 9A). More details on model training and data inference of the performance projection model 420 are discussed herein.

In various embodiments of this application, an information management platform consolidates a plurality of data associated with different projects from multiple data resources and provides supplement information (e.g., performance trend, alert events) for individual projects based on the consolidated data, thereby allowing the projects to be dynamically managed with desirable performance (e.g., meet an expected performance trend, have less issues, have issues addressed or mitigated promptly). The projects are normally managed via an information management application hosted on a server 102.

In some embodiments, a performance trend 620 is predicted using machine learning based on current data collected for the process data 602 and performance data 604. In some embodiments, an alert message is issued indicating that a metric is out of a predefined range, when the host server detects an issue based on the process and performance data. The alert message may provide a subset of process data, performance data, and supplemental data (e.g., associated with the user feedback). A user may choose to explore the issue based on the alert message. Further, in some embodiments, the metric may stay out of the predefined range (e.g., have a “at risk” state) for an extended duration of time (e.g., two weeks). The user may choose to take an action to control the metric into the predefined range. In some embodiments, one of more of the process data, the performance data, the alert message, and the performance trend are consolidated and visualized on a graphical user interface. For example, the user interface includes a dashboard for presenting these information associated with a customer journey. More details on the user interface presenting the process data 602, the performance data 604, the alert message, or the performance trend 620 are discussed below with reference to FIGS. 8, 9A, and 9B.

FIG. 8A is a diagram illustrating an example user interface 800 including a qualitative predicted performance trend 620L, in accordance with some embodiments, and FIG. 8B is a diagram illustrating an example user interface 850 on which an average 716, a standard deviation 718, and thresholds 720 are marked for a curve 704 of a first performance metric 604A, in accordance with some embodiments. A client device 140 executes an information management application 206, and displays the user interface 800 including a subset of current metric indicators with reference to a temporal axis 702. The subset of current metric indicators 616 correspond to five metrics 610, each of which is represented by a respective curve. For example, a first performance metric 604A corresponding to a first curve 704. In some embodiments, an affordance item 712 (e.g., “Add Additional Performance Metrics”) is displayed (e.g., with a dropdown menu 714), allowing a user to add additional curves corresponding to performance metrics onto the user interface 800.

The server system 102 visualizes the predicted performance trend 620 by rendering a representation 620QL corresponding to the predicted performance trend 620 of the first performance metric 604A. In some embodiments, the predicted performance trend 620 is selected from an upward trend 706U, a steady trend 706S, and a downward trend 706D. The server system 102 visualizes the predicted performance trend 620 by displaying the subset of current metric indicators 616 with reference to a temporal axis 702, e.g., on the curve 704, and displaying a trend panel 708 including an arrow 620QL visually indicating the predicted performance trend 620. In some embodiments, an overlaid window 710 is rendered to present information of a plurality of predefined trend options 706U, 706S, or 706D, e.g., in response to a user action with a title of the trend panel 708. Alternatively, in some embodiments not shown, the arrow 620QL is not directly presented with the curve 704, and is displayed in the overlaid window 710 in response to a user action with an affordance item (not shown) displayed with the curve 704. The representation 620QL is determined based on a performance projection model 420 (FIG. 4). In an example, the training data 406 are limited to a subset of historical data 606 recorded for the same month of past years. In another example, the training data 406 is not limited to the subset of historical data 606 recorded for the same month of the past years.

In some embodiments, the predicted performance trend 620 corresponds to a target projection length 622 (e.g., two weeks, a month, a quarter) measured from a current time (e.g., the first time t₁). In some embodiments, a machine learning model 344 (e.g., a performance projection model 420) is applied to generate the predicted performance trend 620, examining current data 614 (e.g., process and performance data) and statistically determine an effect of each metric 610. Historical data 606 are used to train the machine learning model 344 (e.g., a performance projection model 420) before the model 344 is applied to process a subset of current data 614 and determine the predicted performance trend 620, which is qualitatively represented by 620QL.

FIGS. 9A and 9B are two diagram illustrating two example user interfaces 900 and 910 showing quantitative predicted performance trends 620, in accordance with some embodiments, respectively. A client device 140 executes an information management application 206, and displays the user interface 900 including a performance metric curve 902 with reference to a temporal axis 702. A first time t₁ corresponds to June 2023. The performance metric curve 902 is plotted based on historical data 606, current data 614, and a predicted performance trend 620 of a subset of performance metrics 610. In some embodiments, the performance metric curve 902 corresponds to a specific metric 610 listed in FIG. 7. In some embodiments, the performance metric curve 902 corresponds to an ease of doing business (EODB) performance metric, which is determined based on a specific metric 610 listed in FIG. 7 or a combination of a plurality of first performance metrics 604A (FIG. 4).

A historical sample time t_{H} (FIG. 6) corresponds to a respective historical metric indicator of each first performance metric 604A and a historical ease of doing business (EODB) indicator, which is a combination of the respective historical metric indicators 608 of the one or more first performance metrics 604A. A current sample time t_{C} (e.g., a first time t₁) corresponds to a respective current metric indicator 616 of each first performance metric 604A and a current EODB indicator 616C, which is a combination of the respective current metric indicators 616 of the one or more first performance metrics 604A. The predicted performance trend 620 includes a predicted change of the current EODB indicator 616C that has not occurred at the current sample time t_{C}. The predicted performance trend 620 is determined based on a performance projection model 420 (FIG. 4).

In some embodiments, the server system 102 determines a second time t₂ that follows by the first time t₁ by the target projection length 622, collects target data 640 (FIG. 6) between the first time t₁ and the second time t₂, and determines a real performance trend 904 based on at least the target data 640. The performance projection model 420 is further trained using the subset of current metric indicators 616 and a ground truth including the real performance trend 904.

Referring to FIG. 9B, in some embodiments, the server system 102 visualizes the predicted performance trend 620 by rendering a curve 916 corresponding to the predicted performance trend 620 of the one or more first performance metrics 604A. The predicted performance trend 620 is determined based on a performance projection model 420 (FIG. 4), and the curve 916 originates from the subset of current metric indicators 614 and extending towards a direction of the temporal axis 702. In some embodiments, a dashboard page 910 is displayed on a user interface 910 of the information management application 206, summarizing current statuses of a plurality of ongoing projects. For example, the dashboard performance trend with a curve 916 representing a predicted performance trend 620 for a year (e.g., 2023). A performance projection model 420 may be applied to process metric indicators of one or more previous years or early days of the year to generate the predicted performance trend 620 of the year.

In some embodiments, a user receives an alert message associated with a first metric, e.g., on a user interface of the information management application 206, via an email box or a messaging application. In response to the alert message, the user may choose to review a status of the first metric of a corresponding project and investigate an issue associated with the alert message via the information management application.

In some embodiments, the dashboard page 910 includes an alert panel 918 listing numbers 920 of issues identified for a plurality of categories 922 (e.g., corresponding to a plurality of project phases 802 including one or more of awareness, assessment, engagement, usage, reflection). In some embodiments, the alert panel 918 may present a total number 924 of issues identified for all of the plurality of categories 922. In this example, two usage issues are identified. As such, the dashboard page 910 provides a high level overview of the ongoing projects and a line of sight into performance within each category (e.g., corresponding to a phase) of the projects.

In some embodiments, the plurality of categories 922 correspond to user feedback messages 220 that are natural language data collected from individual users in a subjective and descriptive format. A message classification model 430 is applied to extract performance features 216 (FIG. 2) from user feedback messages 220, which may be further classified to a subset of categories 922 based on the performance features 216. In an example, the performance features 216 includes a temporal series of indicators of a satisfaction rate that is generated in real time as a project is implemented. In some embodiments, to determine satisfaction rate, the server system 102 manages a survey including a plurality of queries 222, in response to which user feedback messages 220 are generated. A temporal series of current metric indicators 616 of the satisfaction rate 604-11 are extracted from the plurality of user feedback messages 220. In some embodiments, an alternative server 102B owned by a third party manages the survey and provides the user feedback messages 220 or the current metric indicators 616 of the satisfaction rate 604-11 to the host server 102A. Alternatively, in some embodiments, a first alternative server 102B1 provides the user feedback messages 220 to a second alternative server 102B2, which extracts, and sends to the host device 102A, the current metric indicators 616 of the satisfaction rate 604-11. Additionally, in some embodiments, a message classification model 430 (FIG. 4) is applied by the server system 102 to process each of the plurality of user messages to determine a temporal series of satisfaction states (e.g., happy, disappointed, impatient) corresponding to the satisfaction rate 604-11. A temporal series of satisfaction rates (e.g., quantitative values of 1-5) may be further determined quantitatively for the satisfaction rate 604-11 based on the temporal series of satisfaction states.

Further, in some embodiments, events are detected in the process data 202 or the performance data 204, and classified to one of three event types including “issues found,” “issues at risk,” or “no issue.” In some embodiments, each event having a first event type (e.g., “issue found”) is classified to a respective one of the plurality of categories 922, and reported on the alert panel 918. Stated another way, the actual performance trend 914 is impacted directly by this event type, and corresponding events and issues are identified in the alert panel 918. Further, each event having a second event type (e.g., “issue at risk”) may be determined to be safe in the meantime and have a potential risk in future. Each event having a third event type (e.g., “no issue”) is determined to be safe.

In some embodiments, for each category 922, in response to a user action on the executable information item representing the respective category 922, details of the issues identified for the respective category 922 may be displayed on the user interface. The details of the issues allow deep dive investigation into why corresponding events are flagged as issues, associated thresholds, process data 202, performance data 204 and associated survey responses 210 including user feedback messages 220, and additional information driven from analysis of historical data.

Information displayed on the alert panel 918 is tracked on the server system 102. In some embodiments, the plurality of metrics 610 (FIG. 6) includes a first metric (e.g., visualized by a curve 704 in FIG. 8A). Referring to FIG. 8B, an average 716 and a standard deviation 718 are determined for the first metric (e.g., metric 604A) based on a subset of historical data 606 of the first metric. For example, the subset of the historical data 606 corresponds to the year of 2022. In some embodiments, the subset of historical data 606 corresponds to a length of data history. The length of data history may depend on one or more of a type of the first metric, a user preference, a magnitude of the average 716, a magnitude of the standard deviation 718. In some embodiments, a predefined data selection rule is applied to automatically and dynamically adjust the length of data history for the subset of historical data 606 used to determine the average 716 and the deviation 718 for the first metric.

One or more thresholds 720 are set based on the average 716 and the standard deviation 718 of the first metric. For example, each of the one or more thresholds 720 has a difference from the average, and the difference is a product of a scale factor (e.g., equal to 0.5, 0.7, or 1.4) and the standard deviation 718. The scale factor may depend on one or more of a type of the first metric, a user preference, a timestamp associated with the current data 614, and a recent data characteristic. In some embodiments, a predefined threshold control rule is applied to automatically and dynamically adjust the scale factor used to determine the respective threshold 720.

In real time, while collecting a subset of current data 614 (FIG. 6) corresponding to the first metric, the server system 102 compares each current metric indicator 616 of the first metric with the one or more thresholds 720. Based on a comparison result, the server system 102 generates an alert associated with the first metric. Stated another way, the one or more thresholds are calculated using historical baseline of the average 716 and the standard deviation 718 (normal variability within the metric), e.g., using standard statistical practices. For example, if the metric's most recent bi-weekly interval is moderately worse than normal (e.g., which is approximately one standard deviation 718 from the average 716), the first metric is considered “At Risk”. In some situations, if the metric is significantly worse than normal (approximately two standard deviations 718 from the average 716), the metric will be flagged as “Issue Found.” Note that the direction of movement (higher or lower) being desirable or not is dependent on the first performance metric. For example, an increase in a user engagement rate is desirable, whereas an increase in a turnaround time is not desirable. In some situations, flagging does not guarantee that a problem exists with the metric, and however, indicates that the first performance metric is abnormal and should be investigated or monitored to determine if a real problem does exist.

More specifically, in some embodiments, the alert is created to correspond to a state of a hierarchy of alert states (e.g., “at risk,” “issues found,” “no issues”) defined based on the standard deviation 718. Further, in some embodiments, in accordance with a determination that a current metric indicator 616 of the first metric deviates from the average greater than twice of the standard deviation 718, an issue count (e.g., associated with “issues found” is increased by 1, and the server system 102 enable displaying, in real time and on a user interface, information of the first metric including the issue count. In some embodiments, in accordance with a determination that the current metric indicator 616 of the first metric deviates from the average between the standard deviation 718 and twice of the standard deviation 718, a risk counter (e.g., associated with “at risk”) by 1.

In an example, an average call number for each user application 602-2 is tracked in a respective sampling window 612, independently of call reasons, to determine two associated thresholds (e.g., a first threshold equal to 0.85, a second threshold equal to 0.95). The lower the average call number 602-2, the higher the satisfaction rate 604-11. More specifically, the average call number lower than 0.85 corresponds to “no issue.” The average call number greater than 0.95 corresponds to “at risk,” which may increase an issue count by 1 for the respective sampling window 612. The average call number between 0.85 and 0.95 corresponds to “issue found,” and may need further tracking or analysis.

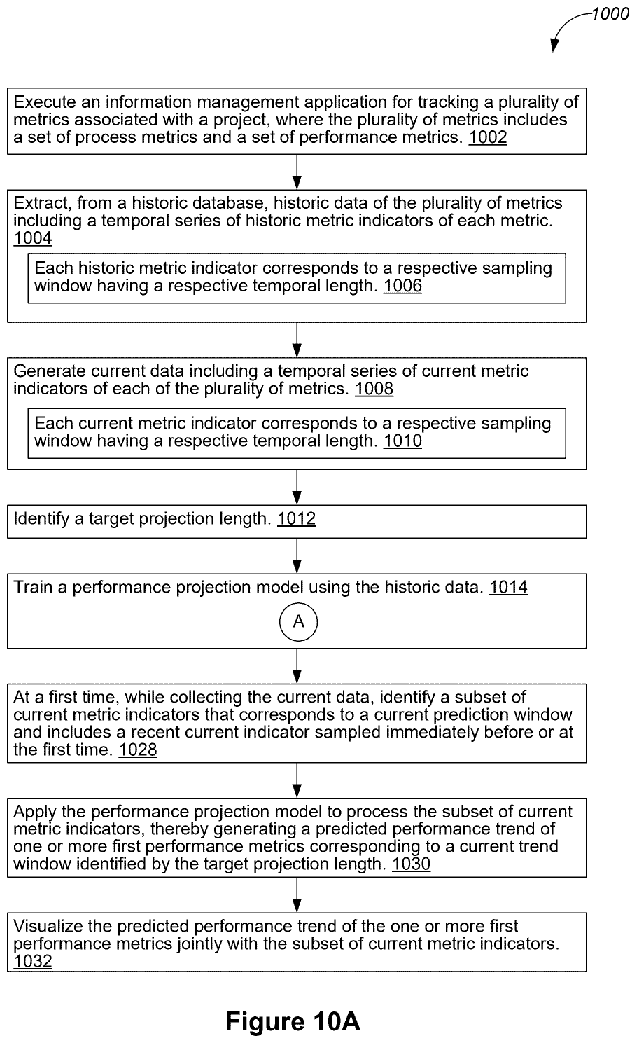

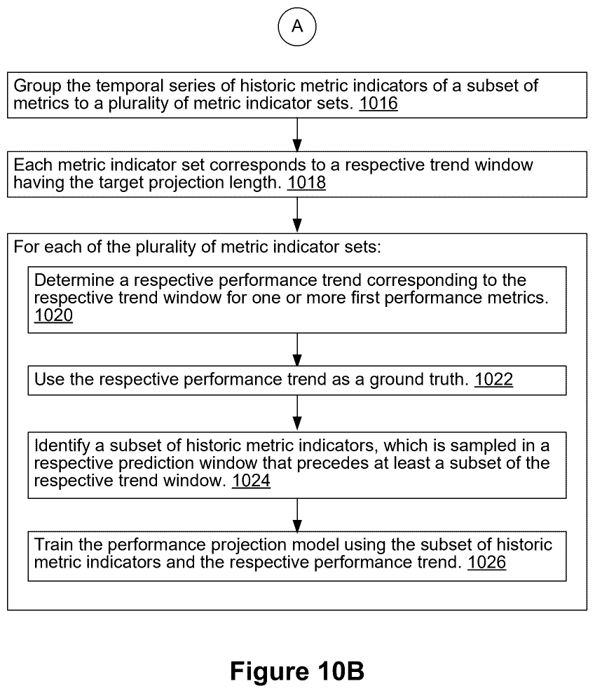

FIGS. 10A and 10B illustrate a flow diagram of an example method 1000 for real-time data prediction and visualization, in accordance with some embodiments. For convenience, the method 1000 is described as being implemented by a computer system. Method 1000 is, optionally, governed by instructions that are stored in a non-transitory computer readable storage medium and that are executed by one or more processors of the computer system. Each of the operations shown in FIGS. 10A and 10B may correspond to instructions stored in a computer memory or non-transitory computer readable storage medium (e.g., memory 306 in FIG. 3A and/or 356 in FIG. 3B). The computer readable storage medium may include a magnetic or optical disk storage device, solid state storage devices such as Flash memory, or other non-volatile memory device or devices. The instructions stored on the computer readable storage medium may include one or more of: source code, assembly language code, object code, or other instruction format that is interpreted by one or more processors. Some operations in method 1000 may be combined and/or the order of some operations may be changed.

The computer system executes (operation 1002) an information management application 206 for tracking a plurality of metrics 610 associated with a project, The plurality of metrics 610 includes a set of process metrics 602 and a set of performance metrics 604. The computer system extracts (operation 1004), from a historical database 346, historical data 606 of the plurality of metrics 610 including a temporal series of historical metric indicators 608 of each metric 610. Each historical metric indicator 608 corresponds (operation 1006) to a respective sampling window 612 having a respective temporal length. The computer system generates (operation 1008) current data 614 including a temporal series of current metric indicators 616 of each of the plurality of metrics 610, and each current metric indicator 616 corresponds (operation 1010) to a respective sampling window 612 having a respective temporal length. The computer system identifies (operation 1012) a target projection length 622, and trains (operation 1014) a performance projection model 420 using the historical data 606.

In some embodiments, the temporal series of historical metric indicators 608 of a subset of metrics are grouped (operation 1016) to a plurality of metric indicator sets. Each metric indicator set corresponds (operation 1018) to a respective trend window 632 having the target projection length 622. For each of the plurality of metric indicator sets, the computer system determines (operation 1020) a respective performance trend 634 corresponding to the respective trend window 632 for one or more first performance metrics 604A, uses (operation 1022) the respective performance trend 634 as a ground truth, identifies (operation 1024) a subset of historical metric indicators 608, which is sampled in a respective prediction window that precedes at least a subset of the respective trend window 632, and trains (operation 1026) the performance projection model 420 using the subset of historical metric indicators 608 and the respective performance trend 634.

At a first time t₁, while collecting the current data 614, the computer system identifies (operation 1028) a subset of current metric indicators 616 that corresponds to a current prediction window and includes a recent current indicator 616A sampled immediately before or at the first time t₁. The computer system applies (operation 1030) the performance projection model 420 to process the subset of current metric indicators 616, thereby generating a predicted performance trend 620 of one or more first performance metrics 604A corresponding to a current trend window 626 identified by the target projection length 622. The computer system visualizes (operation 1032) the predicted performance trend 620 of the one or more first performance metrics 604A jointly with the subset of current metric indicators 616. More details on training and application of the performance projection model 420 are explained above with reference to FIG. 6.

In some embodiments, for a first metric of the plurality of metrics 610, the computer system determines an average 716 and a standard deviation 718 based on the historical data 606 of the first metric, and sets one or more thresholds 720 based on the average 716 and the standard deviation 718 of the first metric. In real time, while collecting a subset of current data 614 corresponding to the first metric, the computer system compares each current metric indicator 616 of the first metric with the one or more thresholds 720. Based on a comparison result, the computer system generates an alert associated with the first metric. Further, in some embodiments, the alert corresponds to a state of a hierarchy of alert states (e.g., “at risk,” “issues found,” “no issue”) defined based on the standard deviation 718. In some embodiments, in accordance with a determination that a current metric indicator 616 of the first metric deviates from the average greater than twice of the standard deviation 718, the computer system increases a total issue count 924 (FIG. 9B) by 1. The computer system displays, in real time and on a user interface 910, information of the first metric including the issue count. Conversely, in some embodiments, in accordance with a determination that the current metric indicator 616 of the first metric deviates from the average 716 between the standard deviation 718 and twice of the standard deviation 718, the computer system increases a risk counter by 1.

In some embodiments, the computer system identifies a plurality of predefined projection lengths and receives a user selection of the target projection length 622 from the plurality of predefined projection lengths.

In some embodiments, the computer system visualizes the predicted performance trend 620 by displaying the subset of current metric indicators 616 with reference to a temporal axis 702 and rendering a curve 902 corresponding to the predicted performance trend 620 of the one or more first performance metrics 604A. Referring to FIG. 9A, the curve 902 may originate from the subset of current metric indicators 616 and extending towards a direction of the temporal axis 702 702.

In some embodiments, the predicted performance trend 620 is selected from an upward trend 704U, a steady trend 704S, and a downward trend 706D. The computer system visualizes the predicted performance trend 620 by displaying the subset of current metric indicators 616 with reference to a temporal axis 702 and displaying an arrow 602QL (FIG. 8A) visually indicating one of the predicted performance trend 620.

In some embodiments (FIG. 7), the set of process metrics 602 include one or more of: a number of requests with not in good order (NIGO) issues, an average call per request, a percentage of paper requests, an average request turnaround time, a percentage of requests requiring asset transfer, and an average asset transfer turnaround time. In some embodiments (FIG. 7), the set of performance metrics 604 include one or more: quality of documents, completing request, finding request, FP portal, accuracy level, submitting request, timeliness, asset transfer, annuity tracking, delivering an insurance policy, and satisfaction level. More examples and correlations of the plurality of metrics 610 are described above with reference to FIG. 7.

In some embodiments, the computer system receives a plurality of user messages in reply to a plurality of queries, and extracts a temporal series of current metric indicators 616 of a second performance metric from the plurality of user messages. Further, in some embodiments, the computer system applies a message classification model to process each of the plurality of user messages to determine a temporal series of satisfaction states corresponding to the second performance metric. A temporal series of satisfaction rates are determined based on the temporal series of satisfaction states corresponding to the second performance metric.

In some embodiments, a historical sample time corresponds to a respective historical metric indicator of each first performance metric and a historical ease of doing business (EODB) indicator, which is a combination of the respective historical metric indicators 608 of the one or more first performance metrics 604A. A current sample time corresponds to a respective current metric indicator 616 of each first performance metric and a current EODB indicator, which is a combination of the respective current metric indicators 616 of the one or more first performance metrics 604A. The predicted performance trend 620 includes a predicted change of the current EODB indicator.

In some embodiments, respective sampling windows 612 of the set of process metrics 602 have a first average temporal length, and respective sampling windows 612 of the set of performance metrics 604 have a second average temporal length that is greater than the first average temporal length.

In some embodiments, for one of the set of metrics, each current or historical metric indicator includes one of (1) a single metric indicator sampled during the respective sampling window and (2) an average of the respective metric indicators sampled during the respective sampling window.

In some embodiments, the computer system determines a second time t₂ that follows by the first time t₁ by the target projection length 622, collects target data between the first time t₁ and the second time t₂, determines a real performance trend 620 904 based on at least the target data, and retains the performance projection model 420 using the subset of current metric indicators 616 and a ground truth including the real performance trend 904.

It should be understood that the particular order in which the operations in FIGS. 10A and 10B have been described are merely exemplary and are not intended to indicate that the described order is the only order in which the operations could be performed. One of ordinary skill in the art would recognize various ways to predict and visualize a data trend. Additionally, it should be noted that details of other processes described above with respect to FIGS. 1-9 are also applicable in an analogous manner to method 1000 described above with respect to FIGS. 10A and 10B. For brevity, these details are not repeated here.

The terminology used in the description of the various described implementations herein is for the purpose of describing particular implementations only and is not intended to be limiting. As used in the description of the various described implementations and the appended claims, the singular forms “a”, “an” and “the” are intended to include the plural forms as well, unless the context clearly indicates otherwise. It will also be understood that the term “and/or” as used herein refers to and encompasses any and all possible combinations of one or more of the associated listed items. It will be further understood that the terms “includes,” “including,” “comprises,” and/or “comprising,” when used in this specification, specify the presence of stated features, integers, steps, operations, elements, and/or components, but do not preclude the presence or addition of one or more other features, integers, steps, operations, elements, components, and/or groups thereof. Additionally, it will be understood that, although the terms “first,” “second,” etc. may be used herein to describe various elements, these elements should not be limited by these terms. These terms are only used to distinguish one element from another.

As used herein, the term “if” is, optionally, construed to mean “when” or “upon” or “in response to determining” or “in response to detecting” or “in accordance with a determination that,” depending on the context. Similarly, the phrase “if it is determined” or “if [a stated condition or event] is detected” is, optionally, construed to mean “upon determining” or “in response to determining” or “upon detecting [the stated condition or event]” or “in response to detecting [the stated condition or event]” or “in accordance with a determination that [a stated condition or event] is detected,” depending on the context.

The foregoing description, for purpose of explanation, has been described with reference to specific embodiments. However, the illustrative discussions above are not intended to be exhaustive or to limit the claims to the precise forms disclosed. Many modifications and variations are possible in view of the above teachings. The embodiments were chosen and described in order to best explain principles of operation and practical applications, to thereby enable others skilled in the art.

Although various drawings illustrate a number of logical stages in a particular order, stages that are not order dependent may be reordered and other stages may be combined or broken out. While some reordering or other groupings are specifically mentioned, others will be obvious to those of ordinary skill in the art, so the ordering and groupings presented herein are not an exhaustive list of alternatives. Moreover, it should be recognized that the stages can be implemented in hardware, firmware, software or any combination thereof.

What is claimed is:

1. A computer implemented method for real-time data prediction and visualization, comprising:
executing an information management application for tracking a plurality of metrics associated with a project, the plurality of metrics including a set of process metrics and a set of performance metrics;
extracting, from a historical database, historical data of the plurality of metrics including a temporal series of historical metric indicators of each metric, each historical metric indicator corresponding to a respective sampling window having a respective temporal length;
generating current data including a temporal series of current metric indicators of each of the plurality of metrics, each current metric indicator corresponding to a respective sampling window having a respective temporal length;
identifying a target projection length;
training a performance projection model using the historical data, further including:
grouping the temporal series of historical metric indicators of a subset of metrics to a plurality of metric indicator sets, each metric indicator set corresponding to a respective trend window having the target projection length;
for each of the plurality of metric indicator sets:
determining a respective performance trend corresponding to the respective trend window for one or more first performance metrics;
using the respective performance trend as a ground truth;
identifying a subset of historical metric indicators, which is sampled in a respective prediction window that precedes at least a subset of the respective trend window; and
training the performance projection model using the subset of historical metric indicators and the respective performance trend; and
at a first time, while collecting the current data, identifying a subset of current metric indicators that corresponds to a current prediction window and includes a recent current indicator sampled immediately before or at the first time;
applying the performance projection model to process the subset of current metric indicators, thereby generating a predicted performance trend of one or more first performance metrics corresponding to a current trend window identified by the target projection length; and
visualizing the predicted performance trend of the one or more first performance metrics jointly with the subset of current metric indicators.

2. The method of claim 1, further comprising, for a first metric of the plurality of metrics:
determining an average and a standard deviation based on the historical data of the first metric;
setting one or more thresholds based on the average and the standard deviation of the first metric;
in real time, while collecting a subset of current data corresponding to the first metric, comparing each current metric indicator of the first metric with the one or more thresholds; and
based on a comparison result, generating an alert associated with the first metric.

3. The method of claim 2, wherein the alert corresponds to a state of a hierarchy of alert states defined based on the standard deviation.

4. The method of claim 2, wherein generating the alert further comprises:
in accordance with a determination that a current metric indicator of the first metric deviates from the average greater than twice of the standard deviation, increasing an issue count by 1; and
displaying, in real time and on a user interface, information of the first metric including the issue count.

5. The method of claim 2, wherein generating the alert further comprises:
in accordance with a determination that the current metric indicator of the first metric deviates from the average between the standard deviation and twice of the standard deviation, increasing a risk counter by 1.

6. The method of claim 1, wherein identifying the target projection length further comprises:
identifying a plurality of predefined projection lengths; and
receiving a user selection of the target projection length from the plurality of predefined projection lengths.

7. The method of claim 1, wherein visualizing the predicted performance trend further comprising:
displaying the subset of current metric indicators with reference to a temporal axis; and
rendering a curve corresponding to the predicted performance trend of the one or more first performance metrics, the curve originating from the subset of current metric indicators and extending towards a direction of the temporal axis.

8. The method of claim 1, wherein the predicted performance trend is selected from an upward trend, a steady trend, and a downward trend, visualizing the predicted performance trend further comprising:
displaying the subset of current metric indicators with reference to a temporal axis; and
displaying an arrow visually indicating one of the predicted performance trend.

9. The method of claim 1, wherein the set of process metrics include one or more of: a number of requests with not in good order (NIGO) issues, an average call per request, a percentage of paper requests, an average request turnaround time, a percentage of requests requiring asset transfer, and an average asset transfer turnaround time.

10. The method of claim 1, wherein the set of performance metrics include one or more:
quality of documents, completing request, finding request, FP portal, accuracy level, submitting request, timeliness, asset transfer, annuity tracking, delivering an insurance policy, and satisfaction level.

11. A computer system, comprising:
one or more processors; and
memory having instructions stored thereon, which when executed by the one or more processors cause the processors to perform operations comprising:
executing an information management application for tracking a plurality of metrics associated with a project, the plurality of metrics including a set of process metrics and a set of performance metrics;
extracting, from a historical database, historical data of the plurality of metrics including a temporal series of historical metric indicators of each metric, each historical metric indicator corresponding to a respective sampling window having a respective temporal length;
generating current data including a temporal series of current metric indicators of each of the plurality of metrics, each current metric indicator corresponding to a respective sampling window having a respective temporal length;
identifying a target projection length;
training a performance projection model using the historical data, further including:
grouping the temporal series of historical metric indicators of a subset of metrics to a plurality of metric indicator sets, each metric indicator set corresponding to a respective trend window having the target projection length;
for each of the plurality of metric indicator sets:
determining a respective performance trend corresponding to the respective trend window for one or more first performance metrics;
using the respective performance trend as a ground truth;
identifying a subset of historical metric indicators, which is sampled in a respective prediction window that precedes at least a subset of the respective trend window; and
training the performance projection model using the subset of historical metric indicators and the respective performance trend; and
at a first time, while collecting the current data, identifying a subset of current metric indicators that corresponds to a current prediction window and includes a recent current indicator sampled immediately before or at the first time;
applying the performance projection model to process the subset of current metric indicators, thereby generating a predicted performance trend of one or more first performance metrics corresponding to a current trend window identified by the target projection length; and
visualizing the predicted performance trend of the one or more first performance metrics jointly with the subset of current metric indicators.

12. The computer system of claim 11, the memory further comprising instructions for:
receiving a plurality of user messages in reply to a plurality of queries; and
extracting a temporal series of current metric indicators of a second performance metric from the plurality of user messages.

13. The computer system of claim 12, the memory further comprising instructions for:
applying a message classification model to process each of the plurality of user messages to determine a temporal series of satisfaction states corresponding to the second performance metric; and
determining a temporal series of satisfaction rates based on the temporal series of satisfaction states corresponding to the second performance metric.

14. The computer system of claim 11, wherein:
a historical sample time corresponds to a respective historical metric indicator of each first performance metric and a historical ease of doing business (EODB) indicator, which is a combination of the respective historical metric indicators of the one or more first performance metrics;
a current sample time corresponds to a respective current metric indicator of each first performance metric and a current EODB indicator, which is a combination of the respective current metric indicators of the one or more first performance metrics; and
the predicted performance trend includes a predicted change of the current EODB indicator.

15. The computer system of claim 11, wherein respective sampling windows of the set of process metrics have a first average temporal length, and respective sampling windows of the set of performance metrics have a second average temporal length that is greater than the first average temporal length.

16. A non-transitory computer-readable storage medium, having instructions stored thereon, which when executed by one or more processors of a server system cause the processors to perform operations comprising:
executing an information management application for tracking a plurality of metrics associated with a project, the plurality of metrics including a set of process metrics and a set of performance metrics;
extracting, from a historical database, historical data of the plurality of metrics including a temporal series of historical metric indicators of each metric, each historical metric indicator corresponding to a respective sampling window having a respective temporal length;
generating current data including a temporal series of current metric indicators of each of the plurality of metrics, each current metric indicator corresponding to a respective sampling window having a respective temporal length;
identifying a target projection length;
training a performance projection model using the historical data, further including:
grouping the temporal series of historical metric indicators of a subset of metrics to a plurality of metric indicator sets, each metric indicator set corresponding to a respective trend window having the target projection length;
for each of the plurality of metric indicator sets:
determining a respective performance trend corresponding to the respective trend window for one or more first performance metrics;
using the respective performance trend as a ground truth;
identifying a subset of historical metric indicators, which is sampled in a respective prediction window that precedes at least a subset of the respective trend window; and
training the performance projection model using the subset of historical metric indicators and the respective performance trend; and
at a first time, while collecting the current data, identifying a subset of current metric indicators that corresponds to a current prediction window and includes a recent current indicator sampled immediately before or at the first time;
applying the performance projection model to process the subset of current metric indicators, thereby generating a predicted performance trend of one or more first performance metrics corresponding to a current trend window identified by the target projection length; and
visualizing the predicted performance trend of the one or more first performance metrics jointly with the subset of current metric indicators.

17. The non-transitory computer-readable storage medium of claim 16, wherein for one of the set of metrics, each current or historical metric indicator includes one of (1) a single metric indicator sampled during the respective sampling window and (2) an average of the respective metric indicators sampled during the respective sampling window.

18. The non-transitory computer-readable storage medium of claim 16, further comprising instructions for:
determining a second time that follows by the first time by the target projection length;
collecting target data between the first time and the second time;
determining a real performance trend based on at least the target data; and
retaining the performance projection model using the subset of current metric indicators and a ground truth including the real performance trend.

19. The non-transitory computer-readable storage medium of claim 16, further comprising instructions for, for a first metric of the plurality of metrics:
determining an average and a standard deviation based on the historical data of the first metric;
setting one or more thresholds based on the average and the standard deviation of the first metric;
in real time, while collecting a subset of current data corresponding to the first metric, comparing each current metric indicator of the first metric with the one or more thresholds; and
based on a comparison result, generating an alert associated with the first metric.

20. The non-transitory computer-readable storage medium of claim 16, wherein visualizing the predicted performance trend further comprising:
displaying the subset of current metric indicators with reference to a temporal axis; and
rendering a curve corresponding to the predicted performance trend of the one or more first performance metrics, the curve originating from the subset of current metric indicators and extending towards a direction of the temporal axis.
